(19) United States
(12) Patent Application Publication
(10) Pub. No.: US 2003/0130874 A1
(43) Pub. Date: Jul. 10, 2003

(54) Medication-partnership program

(76) Inventors: Jeffrey Andrew Borenstein, New York, NY (US); Heskia Heskiaoff, New York, NY (US)

Correspondence Address: Jeffrey Borenstein, M.D., 80 East End Avenue, New York, NY, 10028, US

(21) Appl. No.: 10/038,458

(22) Filed: Jan. 7, 2002

(51) Int. Cl. G06F 17/60

(52) U.S. Cl. 705/3

(57) ABSTRACT

The medication partnership program is a new method of communication between a patient and his/her physician and/or case manager. The invention is a web-based program which enables the physician and case manager to monitor the self report by patients of medication compliance, symptom response, and side effects without a visit to the office. The patient updates information on a daily basis which allows the physician to make appropriate interventions to improve medication compliance and treatment outcome.

### BACKGROUND OF THE INVENTION

In order for a patient to gain the therapeutic benefit of medication, he/she needs to be compliant with the medication regimen. Lack of compliance is one of the key problems faced by physicians and other health care providers. Studies indicate that a significant number of patients who are started on medication do not comply with the treatment regimen for the fall course of treatment. The medication-partnership program has been developed to improve the compliance of patients who have been prescribed medications, in order to improve their ability to gain the therapeutic benefit of the medication.

### BRIEF SUMMARY OF THE INVENTION

The medication-partnership program is a web-based program which improves the compliance of a patient to take his/her medication regimen which has been prescribed by a physician. The program provides for interconnectivity between the patient, the physician, and a case manager to track the patient's report of compliance with medication and the therapeutic effects and side effects of the medicine. The case manager and physician receive daily self reports from the patient and can make appropriate clinical interventions based upon these reports. In addition, the program includes stage specific information regarding the medication.

At the onset of treatment, issues related to beginning treatment are addressed; later in treatment, key information about that stage of treatment is provided. The information is provided in a streaming media format, as well as text-based form.

### DETAILED DESCRIPTION OF THE INVENTION

The medication-partnership program is a web-based program which improves the compliance of a patient to take his/her medication regimen which has been prescribed by a physician. Furthermore, the system provides a mechanism for the physician to observe more frequently the patient's progress in treatment including compliance, symptoms, and side effects. This provides a flag to the physician to make a rapid clinical intervention, if necessary.

When a physician is starting a patient on medication, the physician registers the patient into the program. If the patient is being treated in a managed care setting or a group practice/clinic setting, the registration can be done by a case manager. The case manager logs onto the web site using his own ID and code. He then types in the information about the patient which the program prompts. (See computer printout).

Once registered, the patient will log on to the website each day to report whether or not he has taken the medication, and report about symptoms and side effects. (See computer printout). The physician and case manager will review this information and make clinical interventions.

The system provides for both synchronous and asynchronous communication between the patient and physician, the physician and case manager, and patient and case manager to discuss key issues related to treatment.

In addition to usual clinical practice, the system also serves as a tool for pharmaceutical research to monitor compliance and collect data concerning efficacy and side effects of a particular study medication regimen.

In order to protect the privacy of the patients and file security, the system allows the physician, case manager, and patient to register and access the system through their own separate codes.

1. What we claim as our invention is a web-based program which enables physicians and case managers to monitor the self-report of medication compliance, symptom response, and side effects by patients without a visit to the office.
